(19) United States
(12) Patent Application Publication
(10) Pub. No.: US 2003/0019640 A1
(43) Pub. Date: Jan. 30, 2003

(54) Compositions including a recycled paper by-product and method for using the compositions

(76) Inventor: Billy J. Hatcher, Donie, TX (US)

Correspondence Address: ROBERT W. STROZIER, Suite 930, 2925 Briarpark Drive, Houston, TX, 77042, US

(21) Appl. No.: 10/162,425

(22) Filed: Jun. 4, 2002

Related U.S. Application Data
(60) Provisional application No. 60/296,037, filed on Jun. 5, 2001.

(51) Int. Cl. A62C 2/00

(52) U.S. Cl. 169/47; 169/49; 169/48; 169/46

(57) ABSTRACT

A variety of uses and compositions composed of a recycled paper by-product material formed during the processing of recycled paper and/or its ash residue are disclosed. The by-product, ash residue and/or compositions include them can be used as an absorbent, a fire retarder, a loss circulation additive, a proppant, a fire fighting agent, a temporary landfill agent, a filler for composites, a drilling fluid additive, a concrete moisture retention agent, a soil conditioner, a soil additive, a slow release plant food, or the like and to method for using the compositions.

### RELATED APPLICATIONS

This application claims provisional priority to U.S. Provisional Patent Application Serial No. 60/296,037 filed Jun. 5, 2001.

### BACKGROUND OF THE INVENTION

1. Field of the Invention

The present invention relates to compositions including a recycled paper by-product material and methods for using the by-product material and method for making the compositions.

More particularly, the present invention relates to compositions including a recycled paper by-product formed during the processing of recycled paper where the by-product and/or the compositions can be used as an absorbent, a fire retarder, a loss circulation additive, a proppant, a fire fighting agent, a temporary landfill agent, a drilling fluid additive, a concrete moisture retention agent, a soil conditioner, a soil additive, a slow release plant food, or the like and to method for making and using the compositions.

2. Description of the Related Art

Many materials have been used for loss circulation additives, for absorbents, for propping open fractured formations (proppants), or the like. Many of these materials are natural products such as nut shells, husks, or the like and many are synthetic materials. Many materials have also been used for fire fighting and/or retarding fires; some natural and some synthetic. Many materials have also been used for absorbing spilled materials.

Even though many such materials exist, there is still a need in the art for a new materials that can be used in these areas, especially materials that are a by-product of another manufacturing process.

### SUMMARY OF THE INVENTION

The present invention relates to varied uses of a recycled paper by-product material in its as is state, its partially dried state, or its bone dry state.

The present invention also provides an ash residue of the recycled paper by-product material, where the ash residue is formed by burning the material in an oxygen-containing gas for a time and at a temperature sufficient to combust substantially all combustible components of the material.

The present invention also provides a fuel including a dry by-product material of this invention and optionally a sufficient amount of a hydrocarbon fuel to improve the by-product combustibility.

The present invention also provides a composition for reducing circulation losses during drilling operations including a drill fluid and a sufficient amount of the by-product material to reduce or eliminate loss of fluid circulation during drilling.

The present invention also provides a composition for fighting fires including a slurry of water and a sufficient amount of the recycled paper by-product material of this invention, where the amount if sufficient to form a slurry with water and the material reduces evaporative water loss, improves the supply of water to the fire and acts to smother the fire.

The present invention also provides a proppant composition including a carrier and a proppant comprising a recycled paper by-product material of this invention, a heat treated recycled paper by-product material of this invention, an ash residual a recycled paper by-product material of this invention or mixtures or combinations thereof, where the materials and/or residue prop up a fractured formation.

The present invention also provides a composition for absorbing spills including an amount of a dried or partially dried recycled paper by-product material of this invention in a form designed to absorb at least one times its weight in the spilled material, where the spilled material can be organic such as a hydrocarbon or the like; inorganic such as acids, bases or the like; or any other environmentally hazardous fluid or liquid material. The term organic means any carbon-containing compounds or material. The term inorganic means any compound or material includes no carbon or only trace amount of carbon, where the term trace amount means less than about 0.5 wt % carbon.

The present invention also provides an absorbent bag including a mesh bag filled with an amount of a recycled paper by-product of this invention or an ash residue of a recycled paper by-product of this invention or mixtures or combinations thereof.

The present invention also provides a concrete including a sufficient amount of a recycled paper by-product material of this invention to maintain a given moisture level in the concrete during concrete curing.

The present invention also provides a plant growth medium including soil and an amount of a a recycled paper by-product of this invention to help maintain a given moisture level in the soil between waterings.

The present invention also provides a slow release plant food including a recycled paper by-product material of this invention having absorbed therein or thereon a plant food.

The present invention also provides a slow release biocide including a recycled paper by-product of this invention having absorbed therein or thereon a biocidal solution, an organic biocidal solution and/or a neat liquid biocide, where the term biocide includes, without limitation, insecticides, anti-bacterial agents, fungicides, herbicides, pre-emergent herbicides, anti-viral agents, or the like or mixtures or combinations thereof.

The present invention also provides a slow release insecticide including a recycled paper by-product of this invention having absorbed therein or thereon at least one aqueous insecticidal solution, organic insecticidal solution and/or a neat liquid insecticide.

The present invention also provides a slow release anti-bacterial composition including a recycled paper by-product of this invention having absorbed therein or thereon at least one aqueous anti-bacterial agent solution, organic anti-bacterial agent solution and/or neat liquid anti-bacterial agent.

The present invention also provides a slow release anti-viral composition including a recycled paper by-product of this invention having absorbed therein or thereon at least one aqueous anti-viral agent solution, organic anti-viral agent solution and/or neat liquid anti-viral agent.

The present invention also provides a slow release fungicide including a recycled paper by-product of this invention having absorbed therein or thereon at least one aqueous fungicidal solution, organic fungicidal solution and/or neat liquid fungicide.

The present invention also provides a slow release herbicide including a recycled paper by-product of this invention having absorbed therein or thereon at least one aqueous herbicidal solution, organic herbicidal solution and/or neat liquid herbicide.

The present invention also provides a slow release pre-emergent herbicide including a recycled paper by-product of this invention having absorbed therein or thereon at least one aqueous pre-emergent herbicidal solution, organic pre-emergent herbicidal solution and/or neat liquid pre-emergent herbicide.

The present invention also provides a plant growth medium including the slow release plant food, slow release insecticide, slow release anti-bacterial composition, slow release fungicide, slow release pre-emergent herbicide, slow release herbicide and/or a general purpose biocide of this invention. The medium can also include soil. The term slow release means that the absorbed reagent leaches out of the recycled paper by-product material or the ash thereof, over a period of time. Generally, the period of time can by on the order of hours, days or weeks depending on the absorbed material, the form of the by-product material and the amount of water contacting the by-product material.

The present invention also provides a concrete covering including a recycled paper by-product material of this invention as is or contained in open-weave relatively flat mats.

The present invention also provides fire retardant including a recycled paper by-product material as is or contained in relatively flat open-weave mats containing the by-product of this invention in a substantially water soaked form.

The present invention provides a method for fight fires including the step of applying to a fire a composition including water and a recycled paper by-product material, where the material is substantially non-flammable or fire resistant and decreases the amount of water lost to evaporation and where the composition further acts to smother the fire starving the fire of essential oxidant (air).

The present invention also provides a method for making an absorbent including partially drying the by-product to a state of dryness sufficient for the composition to absorb at least one times its weight in a spilled material.

The present invention also provides a method for making a fire fighting composition comprising a slurring including water and a sufficient amount of a recycled paper by-product to form a slurry, where the slurry reduces water evaporation when the slurry is applied to a fire.

The present invention also provides a method for making a particulate loss circulation additive or proppant comprising drying a recycled paper by-product material of this invention to a state where the by-product does not readily reabsorb water and grinding the dried material to a desired grind ratio or particle size.

The present invention also provides a method for making an ash residue of a recycled paper by-product material of this invention including burning the material in an oxygen-containing gas. After combustion, the composition can be ground to a desired grind ratio or particle size.

The present invention also provides a method absorbing hydrocarbons in water including placing a open-weave bag containing a recycled paper by-product material of this invention or an ash residue of a recycled paper by-product material of this invention or a mixture or combination thereof in the water for a sufficient time to absorb the hydrocarbon.

The present invention also provides a method for recovering hydrocarbons from the by-product material or ash residue of this invention or a mixture or combination thereof including contacting a hydrocarbon-containing by-product material or ash residue of this invention or mixture thereof with steam to form a hydrocarbon-containing steam, condensing the hydrocarbon-containing steam in a separator and separating the hydrocarbon and water to form a reusable by-product material or ash residue of this invention or mixture thereof. The method can also includes a pressing step, where the hydrocarbon-containing material is placed in a press for a time, temperature and pressure sufficient to remove a portion of the absorbed hydrocarbons.

The present invention also provides a composite material including matrix material and a sufficient amount of a dried, fine wool-like material of this invention to improve at least one physical property of the matrix material.

The present invention also provides a method for making a composite material including the step of mixing into a matrix material a sufficient amount of a dried, fine wool-like material of this invention to improve at least one physical property of the matrix material and curing the matrix material to form a cured composite material.

### DETAILED DESCRIPTION OF THE INVENTION

The inventors have found that a by-product of recycling paper processing, sometimes referred to herein as a recycled paper by-product material or RPP, commonly known as sludge to the paper industry has many different and varied uses. The material can be used at least as: (1) an additive to down hole fluids in the oil industry; (2) an absorbent material; (3) an environmental clean up material; (4) a fire fighting material; (5) a soil additive; (6) an animal raising and racing material; or (7) a construction material. The inventor has found that the material can be used as is or after various treatments such as thermal treatments. The inventor has also found that an ash composition prepared by burning the material in a fuel rich oxidation environment is useful as an absorbent for hydrocarbons.

As a down hole fluid additive, the material of this invention can be used: (1) as a loss circulation additive to plug holes in formations to reduce or prevent drill fluid loss into formations during drilling operations; (2) to set plugs; (3) as a proppant during formation fracturing operations; or (4) as an additive to any other type of drilling fluid.

As an absorbent, the material of this invention can be used to cleanup hydrocarbon spills on highways, beaches or the like, where the term hydrocarbon includes, without limitation, fuels such as gasoline, diesel fuel, jet fuel or the like, oils such as motor oil (natural and synthetic), heating oil, gear oil, crude oil or the like; fluids such as transmission fluid, hydraulic fluid or the like; hydrocarbon-containing fluids such as hydrocarbon contaminated water such as water or salt water used in oil and gas well work, oil well reserve pit reclamation and land farming or the like.

For environmental cleanup, the material of this invention can be used on beaches, in animal habitats, forests, wet lands, marsh lands, and to aid in removing oil from animals after oil spills.

Because the material is non-hazardous and helps in water retention, the material is ideally suited for use in environmentally sensitive areas such as wet lands, marshes and/or swamps.

In fire fighting applications, the material of this invention can be used as a slurry that can be pumped or dropped on a fire to reduce water evaporation and to help smoother the fire. A water rich version of the material can also be as a fire retardant or as a material to throw on a fire to retard its growth. A dry form of the material can be applied to the fire with water to reduce water evaporation and aid in fire fighting using water.

The material of the present invention can also be used in soil conditioning providing water retention reservoirs in the soil. The material can also be used an as bedding material for animals, as an absorbent for animals pens, or as filler for walkways, paddock and/or racetracks. The material of the present invention can also be mixed with seed to improve seed spreading and to act as an immediate source of water. Moreover, a dry version of the material can be mixed with a fertilizer or plant food, aqueous or organic, to form a delayed release fertilizer material to improve seed germination, seedling growth and/or plant growth. Furthermore, a dry version of the material can be mixed with an aqueous or non-aqueous insecticide, herbicide, fungicide, anti-bacterial agent, pre-emergent herbicide, or other agent to form a biocide composition to reduce or prevent or eliminate insects, weeds, fungi, bacteria, or the like.

In the construction industry, the material of this invention can be used to help maintain moisture content in green concrete by adding it directly to the concrete mix in an amount between about 1 wt. % and about 10 wt %. A water-rich version of the material can be used to cover freshly poured concrete to reduce water evaporation improving concrete curing. The water-rich version of the material is particularly useful when contained in relatively flat mats of an open-weave material. This form of the material, in open weave bags, can also used to retard fires.

The present invention broadly relates to the use of a by-product material formed during the paper making using recycled paper: in oil drilling operations; in fire fighting; in bio-remediation; in remediation; in environmental cleanup; in hydrocarbon spill cleanup; in soil conditioning; as a bedding material; as a walkway, paddock or racetrack material; in construction; in agriculture or the like.

The present invention also broadly provides compositions of matter comprising: (1) a slurry including water and a sufficient amount of the RPP material to form a slurry, where the material reduces evaporative loss of water and aids in smothering the fire; (2) a soil growth promoter including the RPP material, water and plant fertilizers, nutrients, and/or food; (3) a water saturated composition for fire fighting, concrete curing, or the like; (4) a concrete including a sufficient amount of RPP material to improve concrete cure and cure homogeneity; (5) an ash composition including combustion products of the RPP material for use as a hydrocarbon absorbent in dry and aqueous environments; and (6) a bone dry material for use as a proppant.

The present invention also broadly provides methods for using the material and compositions of this invention including: (1) applying a slurry of this invention to a fire either by pumping the slurry onto the fire or dropping the slurry onto the fire; (2) forming a concrete including a sufficient amount of the material of this invention, pouring the concrete and curing the concrete; (3) mixing seed with a sufficient amount of the material of this invention and spreading the mixture on a soil; (4) adding a sufficient amount of the material to a drilling fluid to reduce or prevent fluid loss during drilling; (5) adding plant food and/or growth promoters to the RPP material as a slow release plant growth promoting material and amending a soil therewith; (6) adding a biocide to the RPP material to form a biocidial composition and applying the composition to an area for biocide treatment, where the composition can be a slow release biocidial composition; (7) filling open weave containers with the RPP material, sealing the containers and applying the containers to an area, where the containers can be bags, mats, blankets, or the like and where the area can be an area of green concrete, an area of contaminated soil, an area of contaminated water (the surface), or any other area or surface that would benefit from application of containers of the RPP material; and (8) other methods for using the RPP material in any of its forms.

The present invention also relates to a method for preparing an ash residue of a RPP material and recover the energy equivalents stored therein. The raw RPP material is commutated in a chopper or grinder to a desired sized material. The commutated material is forwarded to or fed to a rotex type screen and sizer equipped with a vacuum system. Hot dry air is applied to the material to dry the material as the material is being sized. The sizing process results in the production of a plurality of dried and sized materials having different particle size distributions depending on the screen sizes used in the sizing process. Once sized, the coarse material and some finer material can optionally be forwarded via a conveyor system to a diesel application zone where diesel fuel is added to the material, preferably the diesel is added to the material as an aerosol through at least one nozzle connected to a low, moderate or high pressure supply system (pumping unit with control electronics). Sufficient diesel fuel is added to the material to improve the burn rate of the material or to render the material more readily combustible. However, the addition of diesel or other similar hydrocarbon accelerants is not essential, because the dried material itself can be directly burned. Generally, the amount of diesel or added hydrocarbon fuel is between about 0.5 wt % and about 10 wt %, preferably, between about 1 wt % and about 8 wt %, particularly, between about 1 wt % and a about 5 wt %.

The dried material or the diesel-containing material is then forwarded to a furnace where the material or the diesel-containing material is combusted in the presence of an oxygen containing gas to form an ash and to generate thermal energy corresponding to a heat of combustion of the material. The furnace can and preferably is connected to an electricity generation facility to extract energy from the material for the generation of electric energy. However, the generated thermal energy can also be used to transfer heat to a cooler substance in a heat exchanger or used in any other way for any other purpose. The furnace is operated at an elevated temperature for a time sufficient to combust substantially all combustible components of the material. Generally, the temperature is above about 300° C., preferably, the temperature is between about 300° and about 1000° C. Generally, the residence time of the materials is a function of the furnace temperature, but generally ranges from 1 second to 30 minutes in a batch or continuous process. The term to combust substantially all combustible components means that the ash contains less than about 5 wt. % of combustibles, preferably less than about 2 wt % combustibles, particularly, less than about 1 wt % combustibles with the goal of zero wt % combustible an ultimate goal.

The ash is then collected, commutated and sized for the formation of at least one ash residue absorbent product. The dried material can be stored, while diesel-containing material, which can be stored, is preferably burned shortly after diesel application to minimize the possibility of autocatalyzed combustion.

Besides the use of the diesel-containing RPP material as a fuel for generating electricity and to form the ash residue of the present invention, the finer commutated dried by-product can be forwarded via a conveyor system to storage hoppers or bens, where preferably oxygen has been displaced from the dry product with a non-combustible gas such as carbon dioxide, nitrogen, argon or the like. Alternatively, water can be added back to the product. However, the addition of water increases product weight and transportation costs. The dried material can then be used to prepare slurries with water for used in fire fighting, to prepare a soil amendment, to prepare a slow release fertilizer composition by adding contacting the dry RPP material with an organic and/or an aqueous solution of one or more major, minor or trace plant nutrients, to prepare biocides by adding an organic and/or an aqueous solution of one or more biocides, by adding an organic solution and/or an aqueous solution of one or more biocides or by adding one or more neat biocides, to prepare concrete by adding the dried by-product to a conventional or high-strength concrete mix; to prepare coverings including a mesh bag filled with the dried by-product, or to prepare other related products.

The by-product material of this invention contains no hazardous chemical ingredients under OSHA regulation 29 CFR 1910 or 1200 or RCRA 40 CFR part 261. The material has a density of about 0.729 with a water content of about 1% by weight. The material has no vapor pressure and no volatiles. The material is substantially insoluble in water having a water solubility of less than about 0.1%. The material has a pH of about 8.5. The material has no melting point or boiling point. The material has a grayish white to light color and has a slight bleach odor. The material will support combustion only when bone dry. The material is stable. The material generally comprises about 40 wt. % clay; about 30 wt. % fiber (wood pulp or similar fiber material); about 20 wt. % calcium carbonate, about 4 wt. % casein; about 4 wt. % dye, latex and defoamer and about 2 wt. % titanium oxide. The exact composition can vary as much as ±10 wt. % on all major ingredients, i.e., 40 wt. %±10 wt. % clay; about 30 wt. %±10 wt. % fiber (wood pulp or similar fiber material); and about 20 wt. %±10 wt. % calcium carbonate. Thus, the major components, clay, fiber, and calcium carbonate can range between about 50 wt. % and about 30 wt. % for clay, between about 40 wt. % and about 20 wt. % fiber and between about 30 wt. % and about 10 wt. % calcium carbonate. The material can also include other non-hazardous materials as well.

The material of this invention can be used as is generally containing between about 1% and about 50% of its dry weight in water, preferably between about 1% and about 25% of its dry weight in water, particularly between about 1% and about 15% of its dry weight in water, and especially between about 1% and about 5% of its dry weight in water.

The material can also be used in its dried state generally containing less than about 1 wt. % water, where the dried material is substantially free of oxygen containing gas.

The material can also be used as an aqueous slurry, where the slurry can include at least about 1 wt % of the RPP material in water, preferably at least about 10 wt % of the RPP material in water, particularly at least 15 wt. % of the RPP material in water and especially about 25 wt. % of the RPP material in water. Of course, the amount of water should be sufficient to form a slurry and not to result in a water saturated material. Moreover, the slurry can be a slurry that has no free water, i.e., the added water is the amount of water that is completely absorbed by the material—fully water saturated material. The slurry does not have to be stable and should be mixed or shaken before use. However, stable slurries can be produced by adding known suspending agents to the slurry.

The present invention also relates to an ash product formed by burning the RPP material in an oxygen rich environment. The ash material can be used as is, but is preferably placed in container such as a bag made of a mesh material or open weave material including, without limitation, a natural mesh material such as cotton, silk, or the like, or synthetic mesh materials such as rayon, nylon, polyethylene, polypropylene, or the like or mixtures or combinations thereof. The term mesh material means any material through which liquids or fluids can flow. Mesh materials include, without limitation, any material that can be sealed to contain a desired amount of RPP material and is permeable to a material to be absorbed or permeable to a material pre-absorbed on or in the RPP. Exemplary examples of mesh materials include open weave fabrics, semi-permeable membranes, perforated plastic sheets, open weave plastic sheets, or any other non-dissolvable material having opening through which a fluid can flow, but small enough so that substantially all of the RPP material (as is, dried or ashed) does not fall out of the material once placed inside.

The present invention also provides a composite material including a matrix material and a sufficient amount of a dried, fine wool-like material of this invention to improve at least one physical property of the matrix material.

The present invention also provides a method for making a composite material including the step of mixing into a matrix material a sufficient amount of a dried, fine wool-like material of this invention to improve at least one physical property of the matrix material and curing the matrix material to form a cured composite material.

Suitable matrix materials include, without limitation, curable and non-curable polymeric compositions including curable rubber compounds such as compounds used in manufacturing tires, belts and hoses, elastomers such as EPDM rubbers, ene rubbers such as isobutylene, EP rubbers or the like, diene rubbers (homopolymer, copolymer, terpolymer, etc.), diene-monoene elastomer (copolymers, terpolymers, etc.), filled elastomers, plastics, filled plastics, thermal plastics, thermal plastic elastomers, thermosetting resins, curable resins, or any other polymeric matrix material to which the by-product material of this invention can be added to change at least one property of the compositions.

Suitable fillers include, without limitation, clays, silicas, carbon black, or other fibers such as carbon fibers, Kevlar, Telefon, or the like.

Suitable concrete mixes include, without limitation, any conventional or high-strength concrete formulations including those illustrated in U.S. Pat. Nos. 6,239,241; 6,126,875; 5,997,633; 5,993,537; 5,969,053; 5,985,131; 5,858,083; 5,753,744; 5,749,964; 5,852,077; 5,759,260; 5,714,448; 5,709,062; 5,707,445; 5,704,972; 5,683,503; 5,679,150; 5,605,570; 5,605,397; 5,959,595; 5571316; 5,562,767; 5,5207,30; 5,709,962; 5,494,514; and 5,494,513, incorporated herein by reference.

Suitable soils for use with the RPP materials of this invention include, without limitation, any plant growth media such as standard soils, hydroponic media or semi-permeable growth media such as particles of expanded clay, peat, zeolites, fugacites, mulinites, scoria, pumice, perlite soil enhances such as SoilPro, filter media such as charcoal, activated carbon, high surface area ion exchange resins, or other aerated soil alone, in combination or in combination with other standard soil compositions.

Suitable fertilizer for use in the present invention generally include major nutrients: a nitrogen fertilizer, a phosphorous fertilizer, and a potassium fertilizer; minor or secondary nutrients; and trace micro-nutrients. The fertilizer can also include soil amendments. Nitrogen promotes vigorous growth and deep green color, phosphorus which promotes healthy root development, fruit & flower production and can be naturally derived or synthetically derived. Potassium (potash) promotes overall hardiness & good health, fruit & flower production and heat/drought stress tolerance and can be naturally derived or synthetically derived. The minor or secondary nutrients include calcium which promotes early root formation & seedling growth, improves plant vigor and aids in uptake of other nutrients; magnesium which is an essential part of chlorophyll, necessary for formation of sugars, carrier of phosphorus & starches through plant and promotes formation of oils & fats; sulfur which increases root development, helps maintain dark green color, and stimulates seed production. And, the trace nutrients include boron, which promotes early root formation & growth, improves plant vigor & stiffness, and increases yield & improves quality of fruits & vegetables; chlorine which is involved in photosynthesis & chlorophyll production, stimulates enzyme activity, and helps control water loss & moisture stress; cobalt which is needed in nodules of legumes for nitrogen-fixing bacteria and helps improve growth, transpiration & photosynthesis; copper which is involved in chlorophyll production and catalyzes several plant reactions; iron which acts as oxygen carrier, enhances chlorophyll formation, and is essential in metabolizing RNA; manganese which activates several important metabolic reactions, increases availability of calcium, magnesium & phosphorus, and accelerates seed germination & plant maturity; molybdenum which enhances uptake of nitrogen by plants; sodium which plays a role in water regulation & photosynthesis; zinc which is necessary for chlorophyll & amino acid production, and promotes plant growth. All of these minor and trace nutrients can be naturally derived or synthetically derived.

Suitable insecticides for use in this invention include, without limitation: antibiotic insecticides such as abamectin, allosamidin, doramectin, emamectin, eprinomectin, ivermectin, milbemectin, selamectin, spinosad, thuringiensin; or the like; arsenical insecticides such as calcium arsenate, copper acetoarsenite, copper arsenate, lead arsenate, potassium arsenite, sodium arsenite, or the like; botanical insecticides such as anabasine, azadirachtin, d-limonene, nicotine, pyrethrins, cinerin I, cinerin II, jasmolin I, jasmolin II, pyrethrin I, pyrethrin II, quassia, rotenone, ryania, sabadilla, or the like; carbamate insecticides such as bendiocarb, carbaryl, or the like; benzofuranyl methylcarbamate insecticides such as benfuracarb, carbofuran, carbosulfan, decarbofuran, furathiocarb, or the like; dimethylcarbamate insecticides such as dimetan, dimetilan, hyquincarb, pirimicarb, or the like; oxime carbamate insecticides such as alanycarb, aldicarb, aldoxycarb, butocarboxim, butoxycarboxim, methomyl, nitrilacarb, oxamyl, tazimcarb, thiocarboxime, thiodicarb, thiofanox, or the like; phenyl methylcarbamate insecticides such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC, xylylcarb, or the like; dinitrophenol insecticides such as dinex, dinoprop, dinosam, DNOC, or the like; fluorine insecticides such as barium hexafluorosilicate, cryolite, sodium fluoride, sodium hexafluorosilicate, sulfluramid, or the like; formamidine insecticides such as amitraz, chlordimeform, formetanate, formparanate, or the like; fumigant insecticides such as acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, methyl bromide, methylchloroform, methylene chloride, naphthalene, phosphine, sulfuryl fluoride, tetrachloroethane, or the like; inorganic insecticides such as borax, calcium polysulfide, mercurous chloride, potassium thiocyanate, or the like; arsenical insecticides, or the like; fluorine insecticides, or the like; insect growth regulators including chitin synthesis inhibitors such as bistrifluron, buprofezin, chlorfluazuron, cyromazine, diflubenzuron, flucycloxuron, flufenoxuron, hexaflumuron, lufenuron, novaluron, penfluron, teflubenzuron, triflumuron, or the like; juvenile hormone mimics such as epofenonane, fenoxycarb, hydroprene, kinoprene, methoprene, pyriproxyfen, triprene, or the like; juvenile hormones such as juvenile hormone I, juvenile hormone II, juvenile hormone III, or the like; moulting hormone agonists such as chromafenozide, halofenozide, methoxyfenozide, tebufenozide, or the like; moulting hormones such as αa-ecdysone, ecdysterone, or the like; moulting inhibitors such as diofenolan, precocenes, precocene I, precocene II, precocene III, or the like; unclassified insect growth regulators such as dicyclanil, or the like; nereistoxin analogue insecticides such as bensultap, cartap, thiocyclam, thiosultap, or the like; nicotinoid insecticides such as flonicamid, thiamethoxam, or the like; nitroguanidine insecticides such as clothianidin, dinotefuran, or the like; nitromethylene insecticides such as nitenpyram, nithiazine, or the like; pyridylmethylamine insecticides such as acetamiprid, imidacloprid, nitenpyram, thiacloprid, or the like; organochlorine insecticides such as bromo-DDT, camphechlor, DDT, pp ′-DDT, ethyl-DDD, HCH, gamma-HCH, lindane, methoxychlor, pentachlorophenol, TDE, or the like; cyclodiene insecticides such as aldrin, chlorbicyclen, chlordane, chlordecone, dieldrin, dilor, endosulfan, endrin, HEOD, heptachlor, HHDN, isobenzan, isodrin, kelevan, mirex, or the like; organophosphorus insecticides including organophosphate insecticides such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, schradan, TEPP, tetrachlorvinphos, or the like; organothiophosphate insecticides such as dioxabenzofos, fosmethilan, mecarphon, phenthoate, or the like; aliphatic organothiophosphate insecticide such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, IPSP, isothioate, malathion, methacrifos, oxydemeton-methyl, oxydeprofos, oxydisulfoton, phorate, sulfotep, terbufos, thiometon, or the like; aliphatic amide organothiophosphate insecticides such as amidithion, cyanthoate, dimethoate, ethoate-methyl, formothion, mecarbam, omethoate, prothoate, sophamide, vamidothion, or the like; oxime organothiophosphate insecticides such as chlorphoxim, phoxim, phoxim-methyl, or the like; heterocyclic organothiophosphate insecticides such as azamethiphos, coumaphos, coumithoate, dioxathion, endothion, menazon, morphothion, phosalone, pyraclofos, pyridaphenthion, quinothion, or the like; benzothiopyran organothiophosphate insecticides such as dithicrofos, thicrofos, or the like; benzotriazine organothiophosphate insecticides such as azinphos-ethyl, azinphos-methyl, or the like; isoindole organothiophosphate insecticides such as dialifos, phosmet, or the like; isoxazole organothiophosphate insecticides such as isoxathion, zolaprofos, or the like; pyrazolopyrimidine organothiophosphate insecticides such as chlorprazophos, pyrazophos, or the like; pyridine organothiophosphate insecticides such as chlorpyrifos, chlorpyrifos-methyl, or the like; pyrimidine organothiophosphate insecticides such as butathiofos, diazinon, etrimfos, lirimfos, pirimiphos-ethyl, pirimiphos-methyl primidophos, pyrimitate, tebupirimfos, or the like; quinoxaline organothiophosphate insecticides such as quinalphos, quinalphos-methyl, or the like; thiadiazole organothiophosphate insecticides such as athidathion, lythidathion, methidathion, prothidathion, or the like; triazole organothiophosphate insecticides such as isazofos, triazophos, or the like; phenyl organothiophosphate insecticides such as azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3, trifenofos, or the like; phosphonate insecticides such as butonate, trichlorfon, or the like; phosphonothioate insecticides including phenyl ethylphosphonothioate insecticides such as fonofos, trichloronat, or the like; phenyl phenylphosphonothioate insecticides such as cyanofenphos, EPN, leptophos, phosphoramidate insecticides such as crufomate, fenamiphos, fosthietan, mephosfolan, phosfolan, pirimetaphos, or the like; phosphoramidothioate insecticides such as acephate, isofenphos, methamidophos, propetamphos, or the like; phosphorodiamide insecticides such as dimefox, mazidox, mipafox, or the like; oxadiazine insecticides such as indoxacarb, or the like; pyrazole insecticides such as acetoprole, ethiprole, fipronil, tebufenpyrad, tolfenpyrad, vaniliprole, or the like; pyrethroid insecticides including pyrethroid ester insecticides such as acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, permethrin, biopermethrin, transpermethrin, phenothrin, prallethrin, pyresmethrin, resmethrin, bioresmethrin, cismethrin, tefluthrin, terallethrin, tetramethrin, tralomethrin, transfluthrin, or the like; pyrethroid non-ester insecticides such as protrifenbute, or the like; pyrethroid ether insecticides such as etofenprox, flufenprox, halfenprox, pyridalyl, silafluofen, or the like; unclassified insecticides such as chlorfenapyr, closantel, crotamiton, diafenthiuron, EXD, fenazaflor, fenoxacrim, flucofuron, hydramethylnon, isoprothiolane, malonoben, metoxadiazone, nifluridide, pyridaben, pyrimidifen, rafoxanide, sulcofuron, triarathene, triazamate, or the like; or mixtures or combinations thereof.

Suitable plant growth regulators for use in this invention include, without limitation: antiauxins; clofibric acid; TIBA; auxins such as 4-CPA, 2,4-D, 2,4-DB, 2,4-DEP, dichlorprop, fenoprop, LAA, IBA, naphthaleneacetamide, αa-naphthaleneacetic acid, 1-naphthol, naphthoxyacetic acid, potassium naphthenate, sodium naphthenate, 2,4,5-T, or the like; cytokinins such as 21P, benzyladenine, kinetin, zeatin, or the like; defoliants such as calcium cyanamide, dimethipin, endothal, ethephon, metoxuron, pentachlorophenol, thidiazuron, tribufos, or the like; ethylene releasers such as ACC, AVG, etacelasil, ethephon, glyoxime, or the like; gibberellins such as gibberellins, gibberellic acid, or the like; growth inhibitors such as abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, piproctanyl, propham, TIBA, morphactins such as chlorfluren, chlorflurenol, dichlorflurenol, flurenol, or the like; growth retardants such as chlormequat, daminozide, flurprimidol, mefluidide, paclobutrazol, tetcyclacis, uniconazole, or the like; growth stimulators such as brassinolide, hymexazol, or the like; unclassified plant growth regulators such as benzofluor, buminafos, carvone, ciobutide, clofencet, cloxyfonac, cyclanilide, cycloheximide, epocholeone, ethychlozate, ethylene, fenridazon, forchlorfenuron, heptopargil, holosulf, inabenfide, karetazan, methasulfocarb, prohexadione, prohydrojasmon, pydanon, sintofen, triapenthenol, trinexapac, or the like; or mixture or combinations thereof.

Suitable herbicides for use in this invention including, without limitation: amide herbicides such as allidochlor, beflubutamid, benzadox, benzipram, bromobutide, cafenstrole, CDEA, chlorthiamid, cyprazole, dimethenamid, dimethenamid-P, diphenamid, epronaz, etnipromid, fentrazamide, flupoxam, halosafen, isocarbamid, isoxaben, napropamide, naptalam, pethoxamid, propyzamide, quinonamid, tebutam, or the like; anilide herbicides such as benzofluor, chloranocryl, cisanilide, clomeprop, cypromid, diflufenican, etobenzanid, fenasulam, flufenacet, flufenican, mefenacet, mefluidide, monalide, naproanilide, pentanochlor, perfluidone, picolinafen, profluazol, propanil, or the like; arylalanine herbicides such as benzoylprop, flamprop, flamprop-M, or the like; chloroacetanilide herbicides such as acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor, xylachlor, or the like; aromatic acid herbicides including benzoic acid herbicides such as chloramben, dicamba, 2,3,6-TBA, tricamba, or the like; pyrimidinyloxybenzoic acid herbicides such as bispyribac, pyriminobac, or the like; phthalic acid herbicides such as chlorthal, or the like; picolinic acid herbicides such as clopyralid, picloram, or the like; quinolinecarboxylic acid herbicides such as quinclorac, quinmerac, or the like; arsenical herbicides such as cacodylic acid, CMA, DSMA, hexaflurate, MAA, MAMA, MSMA, potassium arsenite, sodium arsenite, or the like; benzoylcyclohexanedione herbicides such as mesotrione, sulcotrione, or the like; benzofuranyl alkylsulfonate herbicides such as benfuresate, ethofumesate, or the like; carbamate herbicides such as asulam, carboxazole, chlorprocarb, dichlornate, fenasulam, karbutilate, terbucarb, or the like; carbanilate herbicides such as barban, BCPC, carbasulam, carbetamide, CEPC, chlorbufam, chlorpropham, CPPC, desmedipham, phenisopham, phenmedipham, phenmedipham-ethyl, propham, swep, or the like; cyclohexene oxime herbicides such as alloxydim, butroxydim, clethodim, cloproxydim, cycloxydim, profoxydim, sethoxydim, tepraloxydim, tralkoxydim, or the like; cyclopropylisoxazole herbicides such as isoxachlortole, isoxaflutole, or the like; dinitroaniline herbicides such as benfluralin, butralin, dinitramine, ethalfluralin, fluchloralin, isopropalin, methalpropalin, nitralin, oryzalin, pendimethalin, prodiamine, profluralin, trifluralin, or the like; dinitrophenol herbicides such as dinofenate, dinoprop, dinosam, dinoseb, dinoterb, DNOC, etinofen, medinoterb, or the like; diphenyl ether herbicides such as ethoxyfen (waiting for TM), or the like; nitrophenyl ether herbicides such as acifluorfen, aclonifen, bifenox, chlomethoxyfen, chlomitrofen, fluorodifen, fluoroglycofen, fluoronitrofen, fomesafen, furyloxyfen, halosafen, lactofen, nitrofen, nitrofluorfen, oxyfluorfen, or the like; halogenated aliphatic herbicides such as alorac, chloropon, dalapon, flupropanate, hexachloroacetone, methyl bromide, monochloroacetic acid, SMA, TCA, or the like; imidazolinone herbicides such as imazamethabenz, imazamox, imazapic, imazapyr, imazaquin, imazethapyr, or the like; inorganic herbicides such as ammonium sulfamate, borax, calcium chlorate, copper sulfate, ferrous sulfate, potassium azide, potassium cyanate, sodium azide, sodium chlorate, sulfuric acid, or the like; nitrile herbicides such as bromobonil, bromoxynil, chloroxynil, dichlobenil, iodobonil, ioxynil, pyraclonil, or the like; organophosphorus herbicides such as amiprofos-methyl, anilofos, bensulide, bilanafos, butamifos, 2,4-DEP, DMPA, EBEP, fosamine, glufosinate, glyphosate, piperophos, or the like; phenoxy herbicides such as bromofenoxim, clomeprop, 2,4-DEB, 2,4-DEP, difenopenten, disul, erbon, etnipromid, fenteracol, trifopsime, or the like; phenoxyacetic herbicides such as 4-CPA, 2,4D, 3,4-DA, MCPA, MCPA thioethyl, 2,4,5-T, or the like; phenoxybutyric herbicides such as 4-CPB, 2,4-DB, 3,4-DB, MCPB, 2,4,5-TB, or the like; phenoxypropionic herbicides such as cloprop, 4-CPP, dichlorprop, dichlorprop-P, 3,4-DP, fenoprop, mecoprop, mecoprop-P, or the like; aryloxyphenoxypropionic herbicides such as chlorazifop, clodinafop, clofop, cyhalofop, diclofop, fenoxaprop, fenoxaprop-P, fenthiaprop, fluazifop, fluazifop-P, haloxyfop, isoxapyrifop, propaquizafop, quizalofop, quizalofop-P, trifop, or the like; phenylenediamine herbicides such as dinitramine, prodiamine, or the like; pyrazolyloxyacetophenone herbicides such as benzofenap, pyrazoxyfen, or the like; pyrazolylphenyl herbicides such as fluazolate, pyraflufen, or the like; pyridazine herbicides such as credazine, flufenpyr, pyridafol, pyridate, or the like; pyridazinone herbicides such as brompyrazon, chloridazon, dimidazon, metflurazon, norflurazon, oxapyrazon, pydanon, or the like; pyridine herbicides such as cliodinate, clopyralid, dithiopyr, fluroxypyr, haloxydine, picloram, picolinafen, pyriclor, thiazopyr, triclopyr, or the like; pyrimidinediamine herbicides such as iprymidam, tioclorim, or the like; quaternary ammonium herbicides such as cyperquat, diethamquat, difenzoquat, diquat, morfamquat, paraquat, or the like; thiocarbamate herbicides such as butylate, cycloate, di-allate, EPTC, esprocarb, ethiolate, isopolinate, metam, methiobencarb, molinate, orbencarb, pebulate, prosulfocarb, pyributicarb, sulfallate, thiobencarb, tiocarbazil, tri-allate, vernolate, or the like; thiocarbonate herbicides such as dimexano, EXD, proxan, or the like; triazine herbicides such as triaziflam, or the like; chlorotriazine herbicides such as atrazine, chlorazine, cyanazine, cyprazine, eglinazine, ipazine, mesoprazine, procyazine, proglinazine, propazine, sebuthylazine, simazine, terbuthylazine, trietazine, or the like; methoxytriazine herbicides such as atraton, methometon, prometon, secbumeton, simeton, terbumeton, or the like; methylthiotriazine herbicides such as ametryn, aziprotryne, cyanatryn, desmetryn, dimethametryn, dipropetryn, methoprotryne, prometryn, simetryn, terbutryn, or the like; triazinone herbicides such as ametridione, amibuzin, hexazinone, isomethiozin, metamitron, metribuzin, or the like; triazole herbicides such as amitrole, cafenstrole, epronaz, flupoxam, or the like; triazolone herbicides such as amicarbazone, carfentrazone, flucarbazone, propoxycarbazone, sulfentrazone, or the like; triazolopyrimidine herbicides such as cloransulam, diclosulam, florasulam, flumetsulam, metosulam, penoxsulam, or the like; uracil herbicides such as butafenacil, bromacil, flupropacil, isocil, lenacil, terbacil, or the like; urea herbicides such as benzthiazuron, buthiuron, cumyluron, cycluron, dichloralurea, ethidimuron, diflufenzopyr, isonoruron, isouron, methabenzthiazuron, monisouron, noruron, tebuthiuron, thiazafluron, or the like; phenylurea herbicides such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron, thidiazuron, or the like; sulfonylurea herbicides such as amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, or the like; unclassified herbicides such as acrolein, allyl alcohol, azafenidin, benazolin, bentazone, benzfendizone, benzobicyclon, buthidazole, calcium cyanamide, cambendichlor, chlorfenac, chlorfenprop, chlorflurazole, chlorflurenol, chlorthal, cinidon-ethyl, cinmethylin, clomazone, CPMF, cresol, dazomet, DCB, dimepiperate, endothal, flumezin, flumiclorac, flumioxazin, flumipropyn, fluoromidine, fluridone, flurochloridone, flurtamone, fluthiacet, haloxydine, indanofan, methazole, methyl isothiocyanate, nipyraclofen, OCH, oxadiargyl, oxaziclomefone, pentachlorophenol, pentoxazone, phenylmercury acetate, prosulfalin, pyrazolynate, pyriftalid, pyrithiobac, quinoclamine, rhodethanil, sulglycapin, thidiazimin, tridiphane, trimeturon, tripropindan, tritac, or the like; or mixtures or combinations thereof.

Suitable fungicides for use in this invention include, without limitation: aliphatic nitrogen fungicides such as butylamine, cymoxanil, dodicin, dodine, guazatine, iminoctadine, or the like; anilide fungicides such as cyprofuram, flusulfamide, ofurace, oxadixyl, pyracarbolid, thifluzamide, tiadinil, or the like; benzanilide fungicides such as benodanil, flutolanil, mebenil, mepronil, salicylanilide, tecloftalam, or the like; furanilide fungicides such as cyclafuramid, fenfuram, furcarbanil, furmecyclox, methfuroxam, or the like; oxathiin fungicides such as carboxin, oxycarboxin, or the like; antibiotic fungicides such as aureofungin, blasticidin-S, cycloheximide, griseofulvin, kasugamycin, natamycin, polyoxins, polyoxorim, streptomycin, validamycin, or the like; strobin fungicides such as azoxystrobin, dimoxystrobin, kresoxim-methyl, metominostrobin, picoxystrobin, pyraclostrobin, trifloxystrobin, or the like; aromatic fungicides such as biphenyl, chloroneb, chlorothalonil, cresol, dicloran, hexachlorobenzene, nitrothal-isopropyl, pentachlorophenol, quintozene, sodium pentachlorophenoxide, tecnazene, or the like; benzimidazole fungicides such as benomyl, carbendazim, chlorfenazole, cypendazole, debacarb, fuberidazole, mecarbinzid, rabenzazole, thiabendazole, or the like; benzimidazole precursor fungicides such as furophanate, thiophanate, thiophanate-methyl, or the like; carbamate fungicides such as diethofencarb, furophanate, iprovalicarb, propamocarb, thiophanate, thiophanate-methyl, or the like; benzimidazolylcarbamate fungicides such as benomyl, carbendazim, cypendazole, debacarb, mecarbinzid, or the like; conazole fungicides such as azaconazole, bromuconazole, climbazole, clotrimazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imazalil, imibenconazole, ipconazole, metconazole, myclobutanil, oxpoconazole, penconazole, prochloraz, propiconazole, quinconazole, simeconazole, tebuconazole, tetraconazole, triadimefon, triadimenol, triflumizole, triticonazole, uniconazole, uniconazole-P, or the like; copper fungicides such as Bordeaux mixture, Burgundy mixture, Cheshunt mixture, copper acetate, copper carbonate, basic, copper hydroxide, copper naphthenate, copper oleate, copper oxychloride, copper sulfate, copper sulfate, basic, copper zinc chromate, cufraneb, cuprobam, cuprous oxide, mancopper, oxine copper, or the like; dicarboximide fungicides such as captafol, captan, folpet, iprodione, procymidone, thiochlorfenphim, vinclozolin, or the like; dinitrophenol fungicides such as binapacryl, dinobuton, dinocap, dinocap-4, dinocap-6, dinocton, dinopenton, dinosulfon, dinoterbon, DNOC, sultropen, or the like; dithiocarbamate fungicides such as azithiram, carbamorph, cufraneb, cuprobam, dazomet, disulfiram, etem, ferbam, mancopper, mancozeb, maneb, metam, metiram, milneb, nabam, polycarbamate, propineb, tecoram, thiram, zineb, ziram, or the like; imidazole fungicides such as cyazofamid, fenapanil, fenamidone, glyodin, iprodione, isovaledione, pefurazoate, triazoxide, see also conazole fungicides, or the like; inorganic fungicides such as potassium azide, potassium thiocyanate, sodium azide, sulfur, see also copper fungicides, see also inorganic mercury fungicides, or the like; mercury fungicides; inorganic mercury fungicides such as mercuric chloride, mercuric oxide, mercurous chloride, or the like; organomercury fungicides such as ethylmercury acetate, ethylmercury bromide, ethylmercury chloride, ethylmercury phosphate, 2-methoxyethylmercury chloride, methylmercury benzoate, methylmercury dicyandiamide, phenylmercuriurea, phenylmercury acetate, phenylmercury chloride, phenylmercury nitrate, phenylmercury salicylate, thiomersal, tolylmercury acetate, or the like; morpholine fungicides such as aldimorph, benzamorf, carbamorph, dimethomorph, dodemorph, fenpropimorph, tridemorph, or the like; organophosphorus fungicides such as ampropylfos, ditalimfos, edifenphos, fosetyl, hexylthiofos, iprobenfos, phosdiphen, pyrazophos, tolclofos-methyl, triamiphos, or the like; organotin fungicides such as decafentin, fentin, tributyltin oxide, or the like; oxazole fungicides such as chlozolinate, dichlozoline, drazoxolon, famoxadone, hymexazol, metazoxolon, myclozolin, oxadixyl, or the like; phenylsulfamide fungicides such as dichlofluanid, tolylfluanid, or the like; phenylurea fungicides such as pencycuron, or the like; polysulfide fungicides such as barium polysulfide, calcium polysulfide, potassium polysulfide, sodium polysulfide, or the like; pyridine fungicides such as buthiobate, dipyrithione, fluazinam, pyridinitril, pyrifenox, pyroxychlor, pyroxyfur, or the like; pyrimidine fungicides such as bupirimate, cyprodinil, diflumetorim, dimethirimol, ethirimol, fenarimol, ferimzone, mepanipyrim, nuarimol, pyrimethanil, triarimol, or the like; pyrrole fungicides such as fenpiclonil, fludioxonil, fluoroimide, or the like; quinoline fungicides such as ethoxyquin, halacrinate, 8-hydroxyquinoline sulfate, quinacetol, quinoxyfen, or the like; quinone fungicides such as benquinox, chloranil, dichlone, dithianon, or the like; quinoxaline fungicides such as chinomethionat, chlorquinox, thioquinox, or the like; thiazole fungicides such as ethaboxam, etridiazole, metsulfovax, octhilinone, TCMTB, thiadifluor, or the like; thiocarbamate fungicides such as methasulfocarb, prothiocarb, or the like; triazole fungicides such as bitertanol, fluotrimazole, triazbutil, see also conazole fungicides, or the like; xylylalanine fungicides such as benalaxyl, furalaxyl, metalaxyl, metalaxyl-M, or the like; unclassified fungicides such as acypetacs, allyl alcohol, anilazine, bentaluron, benzalkonium chloride, benzamacril, benzohydroxamic acid, bethoxazin, bithionol, carpropamid, carvone, chlobenthiazone, chloraniformethan, chloropicrin, cyflufenamid, dazomet, DBCP, dehydroacetic acid, dichlorophen, diclocymet, diclomezine, diethyl pyrocarbonate, diphenylamine, fenaminosulf, fenhexamid, fenitropan, fenoxanil, fenpropidin, ferimzone, flumetover, formaldehyde, furametpyr, hexachlorobutadiene, isoprothiolane, methyl bromide, methyl isothiocyanate, nitrostyrene, nitrothalisopropyl, OCH, 2-phenylphenol, phthalide, probenazole, pyroquilon, quinazamid, silthiofam, sodium orthophenylphenoxide, spiroxamine, thicyofen, tioxymid, trichlamide, tricyclazole, triforine, zarilamid, zinc naphthenate, zoxamide, or the like; or mixtures or combinations thereof.

Suitable acaricides for use in this invention include, without limitation: antibiotic acaricides, abamectin, doramectin, eprinomectin, ivermectin, milbemectin, nikkomycins, selamectin, tetranactin, thuringiensin, or the like; bridged diphenyl acaricides such as azobenzene, benzyl benzoate, bromopropylate, chlorbenside, chlorfenethol, chlorfenson, chlorfensulphide, chlorobenzilate, chloropropylate, dicofol, diphenyl sulfone, dofenapyn, fenson, fentrifanil, fluorbenside, proclonol, tetradifon, tetrasul, or the like; carbamate acaricides such as benomyl, carbanolate, carbaryl, carbofuran, fenothiocarb, methiocarb, metolcarb, promacyl, propoxur, or the like; oxime carbamate acaricides such as aldicarb, butocarboxim, oxamyl, thiocarboxime, thiofanox, or the like; dinitrophenol acaricides such as binapacryl, dinex, dinobuton, dinocap, dinocap-4, dinocap-6, dinocton, dinopenton, dinosulfon, dinoterbon, DNOC, or the like; formamidine acaricides such as amitraz, chlordimeform, chloromebuform, formetanate, formparanate, or the like; mite growth regulators such as clofentezine, dofenapyn, fluazuron, flubenzimine, flucycloxuron, flufenoxuron, hexythiazox, or the like; organochlorine acaricides such as bromocyclen, camphechlor, DDT, dienochlor, endosulfan, lindane, or the like; organophosphorus acaricides; organophosphate acaricides such as chlorfenvinphos, crotoxyphos, dichlorvos, heptenophos, mevinphos, monocrotophos, naled, schradan, TEPP, tetrachlorvinphos, or the like; organothiophosphate acaricides such as amidithion, amiton, azinphos-ethyl, azinphos-methyl, azothoate, benoxafos, bromophos, bromophos-ethyl, carbophenothion, chlorpyrifos, chlorthiophos, coumaphos, cyanthoate, demeton, demeton-O, demeton-S, demeton-methyl, demeton-O-methyl, demeton-S-methyl, demeton-S-methylsulphon, dialifos, diazinon, dimethoate, dioxathion, disulfoton, endothion, ethion, ethoate-methyl, formothion, malathion, mecarbam, methacrifos, omethoate, oxydeprofos, oxydisulfoton, parathion, phenkapton, phorate, phosalone, phosmet, phoxim, pirimiphos-methyl, prothidathion, prothoate, pyrimitate, quinalphos, quintiofos, sophamide, sulfotep, thiometon, triazophos, trifenofos, vamidothion, or the like; phosphonate acaricides such as trichlorfon, or the like; phosphoramidothioate acaricides such as methamidophos, propetamphos, or the like; phosphorodiamide acaricides such as dimefox, mipafox, or the like; organotin acaricides such as azocyclotin, cyhexatin, fenbutatin oxide, or the like; pyrazole acaricides such as acetoprole, fipronil, tebufenpyrad, vaniliprole, or the like; pyrethroid acaricides; pyrethroid ester acaricides such as acrinathrin, bifenthrin, cyhalothrin, cypermethrin, alpha-cypermethrin, fenpropathrin, fenvalerate, flucythrinate, flumethrin, fluvalinate, tau-fluvalinate, permethrin, or the like; pyrethroid ether acaricides such as halfenprox, or the like; quinoxaline acaricides such as chinomethionat, thioquinox, or the like; sulfite ester acaricides such as propargite, or the like; unclassified acaricides such as acequinocyl, arsenous oxide, benzoximate, chloromethiuron, closantel, crotamiton, diafenthiuron, dichlofluanid, disulfiram, fenazaflor, fenazaquin, fenpyroximate, fluacrypyrim, fluenetil, mesulfen, MNAF, nifluridide, pyridaben, pyrimidifen, spirodiclofen, sulfiram, sulfluramid, sulfur, triarathene; or the like, or mixtures or combinations thereof.

Suitable virucides for use in this invention include, without limitation, imanin, ribavirin, or the like, or mixtures or combinations thereof.

Suitable bactericides for use in the present inventon include, without limitation, bronopol, copper hydroxide, cresol, dichlorophen, dipyrithione, dodicin, fenaminosulf, formaldehyde, 8-hydroxyquinoline sulfate, kasugamycin, nitrapyrin, octhilinone, oxolinic acid, oxytetracycline, probenazole, streptomycin, tecloftalam, thiomersal, or the like, or mixture or combination thereof.

Suitable insect attractants for use in this invention include, without limitation, brevicomin, codlelure, cue-lure, disparlure, dominicalure, eugenol, frontalin, gossyplure, grandlure, hexalure, ipsdienol, ipsenol, japonilure, lineatin, litlure, looplure, medlure, megatomoic acid, methyl eugenol, αa-multistriatin, muscalure, orfralure, oryctalure, ostramone, siglure, sulcatol, trimedlure, trunc-call, or the like, or mixtures or combinations thereof.

Suitable nematicides for use in this invention include, without limitation: antibiotic nematicides such as abamectin, or the like; carbamate nematicides such as benomyl, carbofuran, carbosulfan, cloethocarb, or the like; oxime carbamate nematicides such as alanycarb, aldicarb, aldoxycarb, oxamyl, or the like; organophosphorus nematicides; organophosphate nematicides such as diamidafos, fenamiphos, fosthietan, phosphamidon, or the like; organothiophosphate nematicides such as cadusafos, chlorpyrifos, dichlofenthion, dimethoate, ethoprophos, fensulfothion, fosthiazate, heterophos, isamidofos, isazofos, mecarphon, phorate, phosphocarb, terbufos, thionazin, triazophos, or the like; unclassified nematicides such as acetoprole, chloropicrin, dazomet, DBCP, DCIP, 1,2-dichloropropane, 1,3-dichloropropene, metam, methyl bromide, methyl isothiocyanate, xylenols, or the like, or mixtures or combinations thereof.

Suitable plant activators for use in this invention include, without limitation, acibenzolar (A new class of compounds that protect plants by activating their defence mechanisms), or the like.

Suitable pesticide xynergists for use in this invention include, without limitation, piperonyl butoxide, piprotal, propyl isome, sesamex, sesamolin, sulfoxide, or the like, or mixtures or combinations thereof.

Suitable plant growth media include, without limitation, standard soils, hydroponic media or semi-permeable growth media such as particles of expanded clay, peat, zeolites, fugacites, mulinites, scoria, pumice, perlite soil enhances such as SoilPro, filter media such as charcoal, activated carbon, high surface area ion exchange resins, or other aerated soil alone, in combination or in combination with other standard soil compositions.

Of course, any of these above listed biocides can be used individually with the by-product material or ash residue or in any mixture or combination, provided, however, that the mixture or combination is a viable product and the mixed or combined biocides do not interact or react to render the combination or mixture ineffective for its intended purpose.

### EXAMPLES

The following examples are included for the sake of completeness of disclosure and to illustrate the present invention, but in no way are these examples included for the sake of limiting the scope or teaching of this disclosure.

### Example 1

This example illustrates the use of the material of this invention to absorb diesel fuel.

A cup of the material was soaked in diesel fuel to form a diesel saturated material, which includes the amount of water present in the fresh material which can vary from about 1 to about 5 wt. %.

### Example 2

This example illustrates the thermal treatment of fresh material to form a dry material of this invention as.

A cup of the material was heated hot air dried at a temperature between about 300° F. and about 500° F. for 30 minutes to form an air dried material. The air dried material can then be blanketed with CO₂ or any other oxygen displacement gas such as argon, nitrogen or the like to reduce any chance of spontaneous combustion or to reduce any oxidation of the dried material. The dried material can be stored and transported in this form to reduce transportation cost.

### Example 3

This example illustrates the thermal treatment of the material Example 1.

A cup of the diesel saturated material of Example 1 was air dried at a temperature between about 300° F. and about 500° F. for 30 minutes to form an alternate air dried material. The alternate air dried material was then blanketed with CO₂ or any other oxygen displacement gas such as argon, nitrogen or the like to reduce any chance of spontaneous combustion or to reduce any oxidation of the alternate dried material. The alternate dried material can also be stored and transported in this form to reduce transportation cost.

### Example 4

This example illustrates the recovery of diesel from the material Example 1.

A cup of the diesel saturated material of Example 1 placed in a container and steam was passed through the material. The steam was transferred to a condenser/separator, where approximately 90 wt. % to 98 wt. % of the diesel fuel was recovered. The remainder of the diesel was retained in material which can then be air dried as set forth in Example 3.

### Example 5

This example illustrates the flammability properties of fresh material.

A cup of fresh material was heated to a temperature between 1400° F. to 1700° F. before the material will bum in the presence of another fuel such as natural gas, gasoline, diesel fuel or the like.

This material will not bum without the addition of the another fuel.

### Example 6

This example illustrates the flammability of the material Example 3.

A small about of the air dried diesel saturated material of Example 3 was set on fire using a “kitchen” match leaving only a small amount of ash product.

### Example 7

This example illustrates the use and reuse of the ash product of Example 6 as an absorbent.

A cup of the ash product of Example 6 was placed in a nylon mesh bag which was then sealed. The bag was then placed in a container containing two cups of water and 1/2 cup of diesel fuel and left. The bag floated on top of the water for about 30 hours before the bag started to sink.

### Example 8

This example illustrates the use and reuse of the material of Example 3 to remove diesel fule from water.

Two cups of water was place in a container. V₂ cups of diesel fuel was added to the container. 1/4 cups of the material of Example 3 in a nylon mesh bag was placed into the container and removed 3 times. The nylon bag was then subjected to the treatment set forth in Example 4 resulting in recovery of approximately 98 wt. % of the diesel with approximately 2 wt. % adhering to the nylon mesh bag. The steam stripped bag left a slight oil sheen when placed in fresh water, which can be removed by the application of a nylon bag containing fresh material for Example 3.

The above procedure was repeated several times resulting in the removal up to 98 wt. % of diesel fuel in the water each time.

### Example 9

This example illustrates the use of fresh material to absorb oil spills.

1/2 cups of coiling oil was poured onto a cookie sheet. 1 cup of fresh material was poured over the cookie sheet. After 15 to 20 seconds with stirring, the oil soaked material was emptied from the cookie sheet. 1/2 Cups of fresh material was poured onto the cookie sheet to cleanup residual oil reducing or eliminating slip hazard.

### Example 10

This example illustrates the production of a dry, commutated by-product material.

A cup of the by-product material as is was added to a food processor and chopped for 15 seconds. The chopped material was removed from the food processor and allowed to air dry. The product was fluffy and light similar to group up wool.

### Example 11

This example illustrates the preparation of a flammable composition including the dried, commutated material of Example 10 and diesel fuel.

One cup of the material from Example 10 was placed in a 1/2 gallon glass container with a lid. 3 tablespoons of diesel fuel was added to the container. The lid was placed on the container and the container was shaken until all the dust like particles of the material absorbs diesel. The diesel-containing material was transferred to a screened container. The diesel-containing material was set on fire with a kitchen match. The product burned for 5 minutes and 40 seconds. No forced air was added to the flame to increase burn rate. The burning was performed at atmospheric pressure. The burned ash residue comprised 19 teaspoons of ash after burning. 14 teaspoons of fine material (went through the screen) and 5 teaspoons of coarse material (did not go through screen). The two fractions were combined and commutated in a food processor for 15 seconds yielding 17 teaspoons of total ash. Diesel fuel was reapplied to the ash using a pump aerosol applicator. 15 pumps, approximately, 3 teaspoons of diesel fuel was added. All of the diesel fuel as absorbed by the ash residue.

### Example 12

This example illustrates the ash residue prepared in Example 11 does not absorb water, but does absorb diesel fuel.

1 cup of water was place in a container. 2 teaspoons of diesel fuel was added to the container. 4 teaspoons of the ash residue of Example 11 was added to the container. The ash residue absorbed all of the diesel fuel and floated on top of the water. The diesel-containing material was removed from the water and allowed to air dry for 5 minutes. The material was set on fire with a kitchen match. After the diesel fuel was burned off, no change in the ash residue volume was observed. The procedure was repeated several times and each time the residue had same volume after burning off the diesel fuel.

### Example 13

This example illustrates the drying and separation of the material into a wooly form and coarse form of the by-product material.

A cup of the material was heated hot air dried at a temperature between about 300° F. and about 500° F. for 30 minutes to form an air dried material. The material was then separated into a fine and course material using a screen to yield about 40 to about 50 wt. % of a fine wool like material and about 50 to 60 wt. % of a course material.

### Example 14

This example illustrates the use of the by-product material as filler material for making composite board.

2 tablespoons of the dry wool like material of Example 13 was added to 3 teaspoons of Elmers glue. The mixture was stirred and baked in an oven at 500° F. for 30 minutes to yield a composite board.

### Example 15

This example illustrates the use of the by-product material as filler material for making composite paint material.

2 tablespoons of the dry wool like material of Example 13 was added to 3 tablespoons of a white latex paint. The mixture was stirred and baked in an oven at 500° F. for 30 minutes to yield a pliable film composite.

### Example 16

This example illustrates the use of the by-product material as a loss circulation additive for down hole application.

The by-product (“Hatcher Fiber”) was added to barrels of generic drilling mud in two and 6 pounds per barrel. Each material was run through two different disks having 60 microns and 90 microns openings. Measurements where taken at 7.5 minutes and 30 minutes of circulation. The Hatcher Fiber was compared to generic mud #7, Ultra Seal XP, Pru Seal-Fine at the same levels and sizes. The results are shown in Table 1.

TABLE 1

| | | | | | API Values | | |
|---|---|---|---|---|---|---|---|
| | | | | | | Static | |
| | | | | | | Fil- | |
| Fluid Loss Values at 7.5 and 30 Minute Intervals | | | | | | tra- | |
| | | | 7.5 min. | 30 min. | Spurt | tion | PPT |
| | Conc'n. | | value | value | Loss | Rate | Value |
| Material | lb/bbl | Disc | (mL) | (mL) | (mL) | (mL) | (mL) |
| Mud | N/A | 60 μ | 19.77 | 28.16 | 22.76 | 6.13 | 56.32 |
| Mud | N/A | 90 μ | 22.5 | 32.31 | 25.38 | 7.16 | 64.62 |
| Ultra Seal XP | 2 | 60 μ | 10.86 | 17.49 | 8.46 | 4.84 | 34.98 |
| Ultra Seal XP | 2 | 90 μ | 21.95 | 28.22 | 31.36 | 4.56 | 56.44 |
| Ultra Seal XP | 6 | 60 μ | 9.16 | 15.87 | 4.98 | 4.88 | 31.74 |
| Ultra Seal XP | 6 | 90 μ | 15.33 | 19.81 | 21.7 | 3.27 | 39.62 |
| Pru Seal-Fine | 2 | 60 μ | 12.4 | 19.53 | 10.54 | 5.23 | 39.06 |
| Pru Seal-Fine | 2 | 90 μ | 23.48 | 30.09 | 33.66 | 4.84 | 60.18 |
| Pru Seal-Fine | 6 | 60 μ | 10.1 | 17.3 | 5.8 | 5.26 | 34.6 |
| Pru Seal-Fine | 6 | 90 μ | 17.24 | 22.98 | 23 | 4.19 | 45.96 |
| Hatcher Fiber | 2 | 60 μ | 17.18 | 23.68 | 18.24 | 6.68 | 48.4 |
| Hatcher Fiber | 2 | 90 μ | 26.29 | 32.54 | 40.08 | 4.56 | 65.05 |
| Hatcher Fiber | 6 | 60 μ | 11.57 | 17.57 | 11.52 | 4.89 | 38.32 |
| Hatcher Fiber | 6 | 90 μ | 19.58 | 28.97 | 30.38 | 4.3 | 53.94 |

All references cited herein are incorporated by reference. While this invention has been described fully and completely, it should be understood that the invention may be practiced otherwise than as specifically described. Although the invention has been disclosed with reference to its preferred embodiments, from reading this description those of skill in the art may appreciate changes and modification that may be made which do not depart from the scope and spirit of the invention as described above.

I claim:

1. A fuel comprising a dry recycled paper by-product material, where the material has a water content of less than about 1 wt %.

2. The fuel of claim 1, further comprising a hydrocarbon fuel in an amount sufficient to improve a rate of combustion of the material.

3. The fuel of claim 2, wherein the amount of hydrocarbon fuel is between about 0.5 wt % and about 10 wt %.

4. A method for burning a recycled paper by-product material, the method comprising the step of:
burning the material in an oxygen-containing gas for a time and at a temperature sufficient to combust substantially all combustion components of the material to form an ash and thermal energy corresponding to a heat of combustion of the material; and
using the thermal energy in a subsequent process.

5. The method of claim 4, wherein the subsequent process is a heat exchange process or an electrical generation process.

6. An ash of claim 4.

7. A composition for absorbing spilled materials comprising a recycled paper by-product material dried to a state of dryness sufficient for the material to absorb at least one times its weight in the spilled material, an ash of the recycled paper by-product or mixtures or combinations thereof.

8. A permeable container comprising an outer permeable material surrounding a desired about of a recycled paper by-product material, an ash residue of a recycled paper by-product or a mixture thereof.

9. The container of claim 8, wherein the material is dried to a state of dryness sufficient for the material to absorb at least one times its weight in a spilled material.

10. The container of claim 8, wherein the spilled material is selected from the group consisting of an organic material, an inorganic material, an environmentally hazardous fluid or liquid material, and mixtures thereof.

11. A method cleaning up a spilled material, the method comprising the step of:
contacting a recycled paper by-product material dried to a state of dryness sufficient for the material to absorb at least one times its weight in the spilled material, an ash of the recycled paper by-product or mixtures or combinations thereof with a spilled material for a sufficient time to absorb a desired amount of the spilled material.

12. The method of claim 11, further comprising the step of recovering the spilled material.

13. The method of claim 11, wherein the spilled material is a hydrocarbon and the recovering step includes:
pressing the material for a time, temperature and pressure sufficient to remove a portion of the hydrocarbon to form an intermediate material; and
steaming treating the intermediate material for a time, temperature and pressure sufficient to remove substantially all of the hydrocarbon.

14. A composition comprising a recycled paper by-product material and at least one reagent selected from the group consisting of a fertilizer, a plant growth promoter, a biocide, and mixture or combinations thereof.

15. The composition of claim 14, further comprising a plant growth medium.

16. The composition of claim 15, wherein the reagent is a fertilizer, a plant growth promoter or mixture thereof and composition releases the fertilizer and/or the prompter over an period of time.

17. The composition of claim 14, wherein the reagent is a biocide.

18. The composition of claim 17, wherein the biocide is selected from the group consiting of an insecticide, an anti-bacterial agent, a fungicide, an herbicide, a pre-emergent herbicide, an anti-viral agent, and mixtures or combinations thereof.

19. The composition of claim 18, wherein the biocide is an insecticide.

20. The composition of claim 18, wherein the biocide is an anti-bacterial agent.

21. The composition of claim 18, wherein the biocide is an anti-viral agent.

22. The composition of claim 18, wherein the biocide is a fungicide.

23. The composition of claim 18, wherein the biocide is an herbicide.

24. The composition of claim 18, wherein the biocide is a pre-emergent herbicide.

25. A loss circulation composition for reducing circulation losses during drilling operations including a drilling fluid and a sufficient amount of a recycled paper by-product material to reduce or eliminate loss of fluid circulation during drilling.

26. A proppant composition including a carrier and a proppant selected from the group consisting of a recycled paper by-product material, a heat treated recycled paper by-product material, and an ash residual of a recycled paper by-product material and mixtures or combination thereof, where the proppant props open openings in a fractured formation.

27. A method for making a particulate loss circulation additive or proppant comprising drying the by-product to a states where the by-product does not readily reabsorb water.

28. A composition for fighting fires comprising a slurry including water and an amount of a recycled paper by-product material, where the amount of material is sufficient to form a slurry and the material reduces evaporative water loss, improves the supply of water to the fire and acts to smother the fire.

29. The composition of claim 28, wherein the slurry in contained in a closed container designed to be poured or dropped onto a fire.

30. The composition of claim 28, wherein the slurry includes no free water

31. The composition of claim 31, wherein the slurry is contained in a relatively flat open-weave mats.

32. A method for fight fires including the step of:
applying to a fire a composition including water and a recycled paper by-product material, where the material is present in an amount sufficient to decrease the amount of water lost to evaporation when applying the composition to the fire and the composition acts to smother the fire starving the fire of air.

33. A concrete comprising a concrete including an amount of a recycled paper 0by-product material, where the amount of material is sufficient to maintain a given moisture level in the concrete during concrete curing.

34. A composite material including matrix material and a sufficient amount of a dried, fine wool-like material of this invention to improve at least one physical property of the matrix material.
